(19) United States
(12) Patent Application Publication
(10) Pub. No.: US 2007/0108298 A1
(43) Pub. Date: May 17, 2007

(54) Smart Card Body, Smart Card and Manufacturing Process for the Same

(76) Inventors: Sebastien Kalck, Bischwiller (FR); Frederic Morgenthaler, Seltz (FR)

Correspondence Address: BARLEY SNYDER, LLC, 1000 WESTLAKES DRIVE, SUITE 275, BERWYN, PA, 19312, US

(21) Appl. No.: 11/558,780

(22) Filed: Nov. 10, 2006

(30) Foreign Application Priority Data
Nov. 14, 2005 (EP) 05292410.7

(51) Int. Cl. G06K 19/06

(52) U.S. Cl. 235/492

(57) ABSTRACT

The present invention relates to a smart card body, a smart card, and a manufacturing process for the same, and in particular to smart cards used for subscriber identity modules (SIM) cards. To improve a process for the manufacture of a smart card body and a process for the assembly of a smart card in such a manner that a simple and adaptable process can be achieved for the manufacture of a smart card, a process for the manufacture of a smart card body (10) for incorporating a semiconductor chip is described, wherein the process comprises the formation of a lead frame (3) in a conductive layer (1), wherein the lead frame has first contacts (2) on a first surface and can be connected to the semiconductor chip on a second surface opposite the first surface, and the formation of a electrically insulating casing layer (11) on the second surface of the smart card body, wherein the casing layer (11) has a recess (12) for incorporating the semiconductor chip.

### FIELD OF THE INVENTION

The present invention relates to a smart card body, a smart card and a manufacturing process for same, and in particular to smart cards used for subscriber identity modules (SIM) cards.

### BACKGROUND

According to a conventional manufacturing process for a smart card, a smart card body and a chip card module are manufactured separately. The chip card module is normally embedded in the smart card body before the smart card body provided with the chip card module is cut out.

U.S. Pat. No. 6,288,904 shows a chip card module that is incorporated in a smart card body. A chip is positioned on a circuit carrier and connected to contacts on the opposite site of the circuit carrier by means of wire bonds. The chip is enclosed in a frame which is surrounded with a filling to protect the chip and the wire bonds from mechanical stress.

From U.S. Pat. No. 5,147,982 an encapsulation process for a semiconductor chip in a micromodule is known, wherein the micromodule can then be incorporated in a card. A pre-punched metallic layer is formed, a pre-perforated plastic layer is applied to the metallic layer and a semiconductor chip is positioned on the surface of the metallic layer in a perforation of the plastic layer. A protective ring, which surrounds the chip, is filled with protective material, for example a silicone resin.

In the case of the known manufacturing processes, the chip card modules and smart card bodies are manufactured separately and the chip card module manufactured separately has to be incorporated in a smart card body to produce a smart card, something that results in a complicated manufacturing process.

The European patent application EP 1 554 754 describes a manufacturing process for a data carrier, in particular for a GSM plug body, wherein a data carrier is manufactured on a carrier strip. The data carrier has a data carrier body, which is provided with an electronic component, and the carrier strip has a large number of carrier elements. The manufacturing process comprises injection molding around the carrier elements of the carrier strip to produce a large number of data carrier bodies, and connection of the electronic components to the data carrier bodies to produce a large number of data carriers.

In this manufacturing process for data carriers, the large number of data carriers are manufactured with the electronic component incorporated in the data carrier body and the data carriers are manufactured on a single carrier strip so that it is possible to reduce the manufacturing costs. This manufacturing process for a data carrier is however not flexible enough as the data carrier is manufactured with the electronic component.

There is therefore a need for a flexible and simple manufacturing process for a smart card body and an assembly process for a smart card which are compatible with a roll-to-roll process.

### SUMMARY

An object of the invention, among others, is thus to improve a process for the manufacture of a smart card body and a process for the assembly of a smart card in such a manner that a simple and adaptable process can be achieved for the manufacture of a smart card.

This and other objects are achieved by a method for the manufacture of a smart card body adapted for incorporating a semiconductor chip. The method including the steps of forming a lead frame in a conductive layer, wherein the lead frame has a first contact on a first surface and can be connected to a semiconductor chip on a second surface opposite the first surface; and forming an electrically insulating casing layer on the second surface, wherein the casing layer has a recess for incorporating the semiconductor chip.

Furthermore a smart card having a semiconductor chip and a smart card body is described. The smart card body having a conductive layer structured to form a lead frame having a first surface having first contacts and a second surface opposite the first surface, the second surface being connectable to the semiconductor chip and an electrically insulating casing layer on the second surface, the casing layer having a recess for incorporating the semiconductor chip. The semiconductor chip is affixed in the recess and a surface layer is located on the smart card body for closing the recess.

### BRIEF DESCRIPTION OF THE DRAWINGS

The invention is explained in greater detail below with reference to the accompanying figures of which:

FIG. 1 is a top view of a first side of a carrier strip, which is at a first step of the manufacturing process for a smart card body according to the present invention;

FIG. 2 is a top view of a first side of a carrier strip, which is at a second step of the manufacturing process for a smart card body according to the present invention;

FIG. 3 is a top view of a first side of a carrier strip, which is at a third step of the manufacturing process for a smart card body according to the present invention;

FIG. 4 is a top view of a second side of the carrier strip shown in FIG. 3;

FIG. 5 is a sectional view through the carrier strip shown in FIG. 4 along the section line A-A;

FIG. 6 is an enlarged view of the section shown in FIG. 5.

### DETAILED DESCRIPTION OF THE EMBODIMENTS

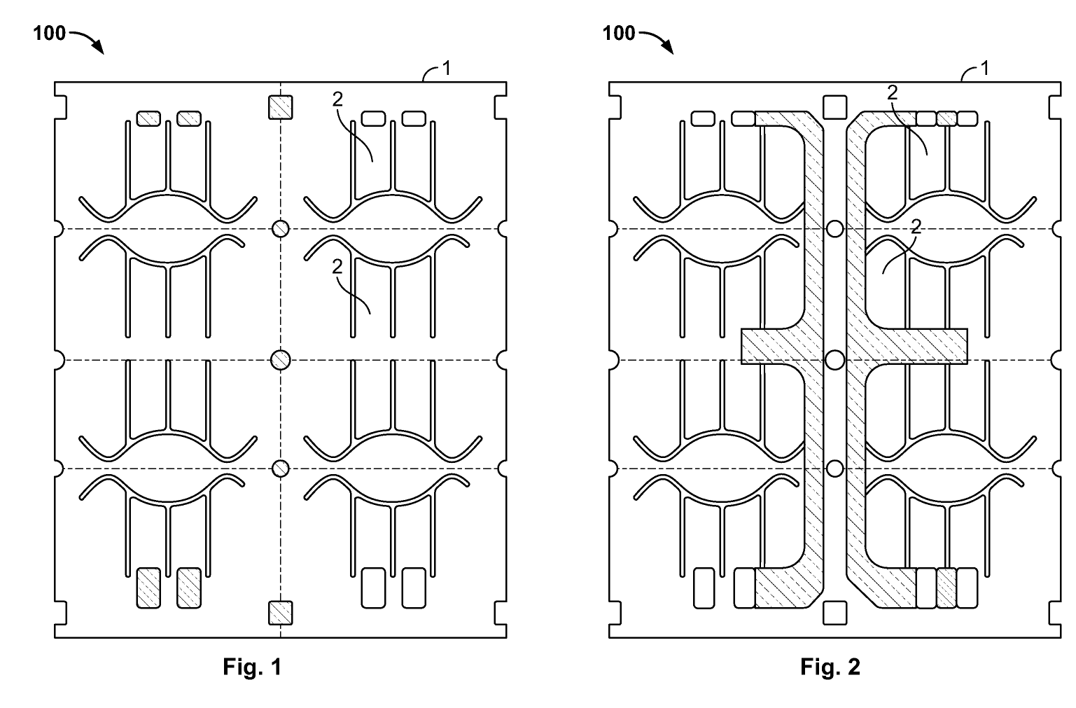

FIGS. 1, 2 and 3 show a top view of a first surface of a carrier strip. FIG. 4 shows a top view of a second surface opposite the first surface. FIGS. 1, 2 and 3 and FIG. 4 thus show top views of the two sides of the smart card body according to the invention.

As can be seen from FIG. 1, a large number of smart card bodies 10 are manufactured on a carrier strip 100. The carrier strip 100 is formed by a conductive layer 1, which preferably consists of copper sheeting. Other conductive materials are however also possible, for example aluminum. The carrier strip 100 preferably consists of a roll of the conductive layer 1 so that the large number of smart card bodies 10 can be manufactured by means of a roll-to-roll process.

The process for the manufacture of a smart card body 10 for incorporating a semiconductor chip is explained with the help of FIGS. 1, 2 and 3.

First of all the conductive layer 1 is punched out, and a lead frame formed in the conductive layer 1. On a first surface of the conductive layer 1, which is shown in FIG. 1, the lead frame has first contacts 2, and the conductive layer 1 is punched out along the roll by a punching tool (shown in FIG. 1 by the black punch-outs). As can be seen from FIGS. 1, 2 and 3, two smart card bodies 10 are manufactured within a single width of the conductive roll. It is of course also possible to select a different number of smart card bodies within the width of the roll.

Once the conductive layer 1 has been punched out and the lead frame formed, the contacts 2 arranged on the first surface are metallized. The first contacts 2 are preferably coated with nickel and nickel-phosphorus using an electroplating process. Other metallization processes for the punched-out conductive layer 1 are however also possible, for example sputtering, vapor-deposit or such methods. The second surface of the conductive layer 1 (not shown in FIGS. 1, 2 and 3) is provided with second contacts 13, which are preferably made of gold. These second contacts 13 are used to connect the semiconductor chip to be incorporated with the first contacts 2 of the lead frame. The semiconductor chip is preferably connected to the second contacts 13 via wire bonds.

A pre-punched dielectric layer (not shown in FIGS. 1, 2 and 3) is then laminated onto the second surface of the conductive layer 1. The dielectric layer is pre-punched in such a manner that the second contacts 13 correspond to the punch-outs of the dielectric layer.

The dielectric layer is then activated by means of a laser treatment, wherein said laser treatment increases the roughness of the surface of the dielectric layer. This process step is necessary to ensure that the injection-molded plastics material applied in a subsequent process step adheres to the surface of the dielectric layer.

As can be seen from FIG. 2, punching dies punch out the carrier strip 100 (shown by the black punch-outs), thus creating the form of the smart card body 10.

According to an advantageous embodiment of the present invention two smart card bodies 10 are manufactured within a single width of the roll and a punching tool punches out the first half of each of two first smart card bodies while a second punching tool punches out the second half of each of two second smart card bodies, as can be seen from FIG. 2. Movement along the roll thus allows the two halves of two smart card bodies to be punched out within one width of the roll and the form of the smart card body to be created.

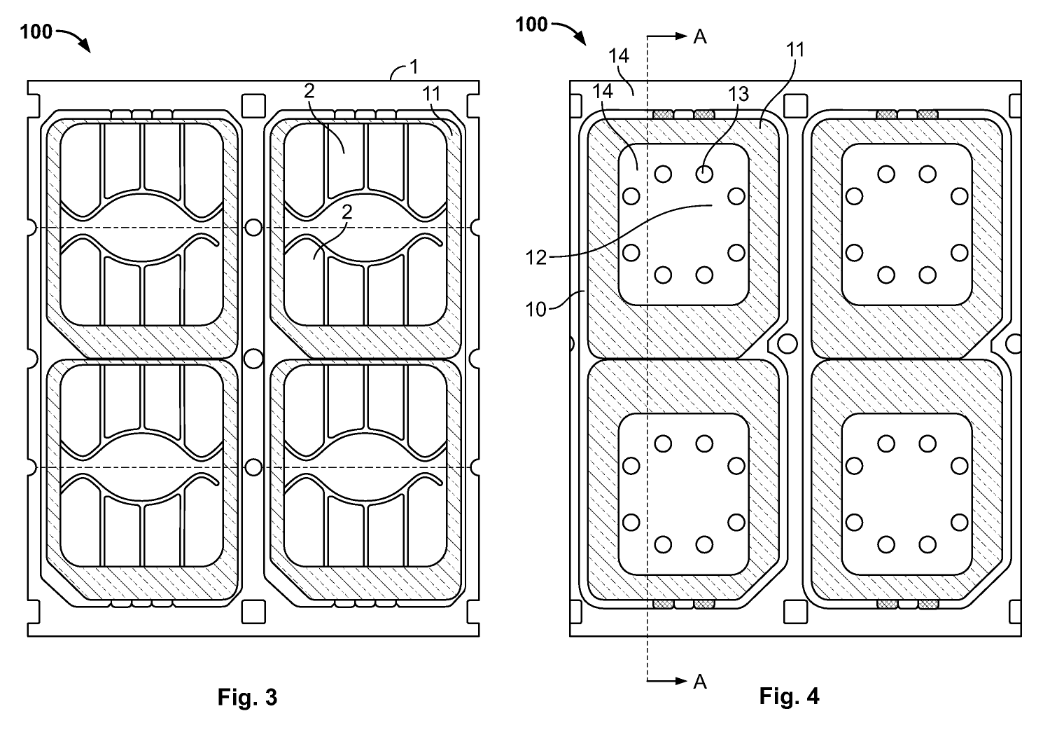

As can be seen from FIG. 3, a casing layer 11 is then formed from insulating injection-molded material on the second surface of the smart card body. Here plastic material is injection-molded around the laminated conductive layer 1. The injection-molded casing layer 11 thus forms an edge on all sides of the smart card body 10 both around the first and the second contacts 2, 13, and the smart card body 10 so formed preferably corresponds to the format of a 3FF smart card.

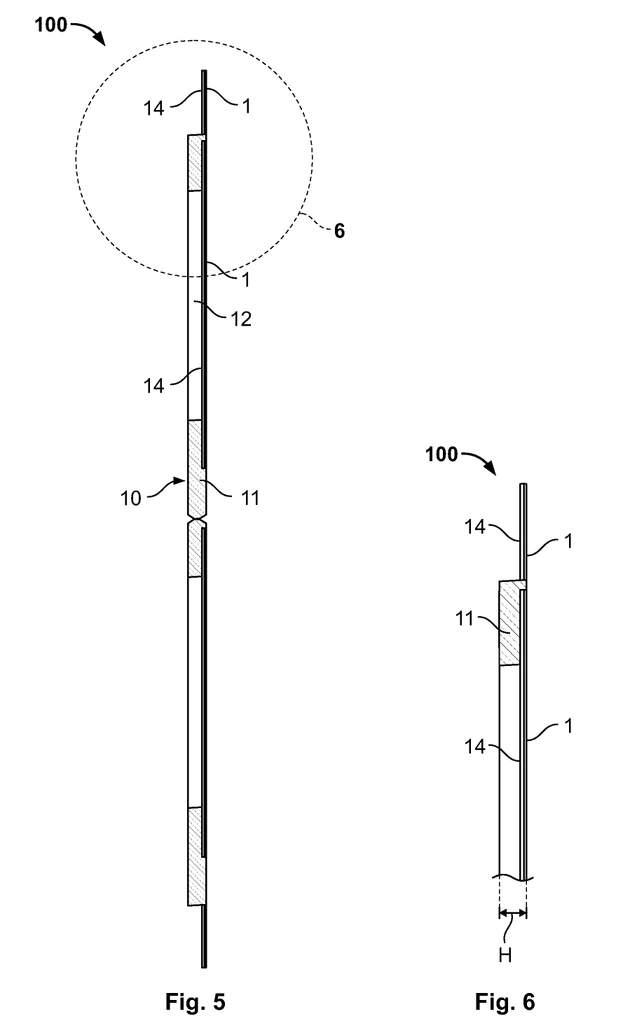

FIG. 4 shows a top view of the second surface of the smart card body 10 and FIG. 5 shows a section through the carrier strip 100 along the section line A-A shown in FIG. 4. FIG. 6 shows an enlarged view of detail VI of the section shown in FIG. 5.

As can be seen from FIG. 4, the casing layer 11 has a recess 12 for incorporating a semiconductor chip. The second contacts 13 are arranged on the conductive layer 1 and the dielectric layer 14 laminated to the conductive layer 1 is pre-punched in such a manner that the second contacts 13 are accessible for contacting to a semiconductor chip to be incorporated.

As can be seen from FIGS. 5 and 6, the combined height of the casing layer 11 and the surface layer (not shown in the figures), which is laminated onto the casing layer 11 in a subsequent process step for the assembly of a smart card, corresponds to the thickness of a smart card according to the 3FF format. The height of the casing layer 11 preferably has a value H of 0.7 millimeters, while the thickness of the laminated surface layer has a value of 0.1 millimeters. As can be seen from FIG. 6, the height H of the casing layer 11 encompasses the distance between the first surface of the injection-molded material arranged level with the first surface of the conductive layer 1 and the second surface of the injection-molded material, to which the surface layer is laminated.

The assembly of a smart card is explained in greater detail below.

A semiconductor chip is fitted in the recess 12 of the casing layer 11 of the smart card body 10. The semiconductor chip is preferably glued to the dielectric layer 14. Alternatively, the semiconductor chip can also be directly affixed to the conductive layer 1. The recess 12 provided with the semiconductor chip in the casing layer 11 of the smart card body 10 is then closed. A strip is preferably laminated onto the recess 12 in the casing layer 11.

According to an advantageous embodiment of the present invention a large number of smart card bodies 10 are manufactured on a carrier strip 100 by means of a roll-to-roll process. This simplifies the manufacturing process of a smart card as a carrier strip can be supplied to a smart card manufacturer, who then only needs to carry out the process steps involving installation of a semiconductor chip and closing of the casing layer 11. As the large number of smart card bodies 10 can be detached from the carrier strip 100, the smart cards only need to be separated after assembly.

The process for the manufacture of a smart card body according to the present invention allows the manufacture of Subscriber Identity Module (SIM) cards to be made more flexible and simple. Smart card bodies 10 can be manufactured on a carrier strip 100 by means of a roll-to-roll process and such a carrier strip 100 can be subsequently supplied to a smart card manufacturer, who then only needs to install a semiconductor chip and close the smart card body to produce a smart card.

The process thus manufactures a smart card body which is adapted to incorporate a semiconductor chip. Incorporation of the semiconductor chip does not take place until the assembly of a smart card, which comprises a smart card body and a semiconductor chip incorporated therein. According to the present invention a process is thus described wherein a smart card body, which does not yet contain a semiconductor chip, is manufactured. This has the advantage that the manufacture of a smart card can take place in a particularly flexible manner.

The possibility of not only manufacturing a smart card body but also performing the assembly of a smart card by means of a roll-to-roll process also makes the manufacture of a smart card particularly simple. A roll of smart card bodies can be simply supplied to a smart card manufacturer, who then only needs to install the semiconductor chips and close the smart card bodies provided with the semiconductor chips as the final process steps. In addition, the personalization of a smart card can be carried out by the smart card manufacturer using a roll-to-roll-process by laminating a personalized strip onto the smart card bodies provided with the semiconductor chips.

The manufacture of a smart card is also particularly simplified because the smart card manufacturer no longer has to carry out the steps involving detachment of the smart card module and embedding of the smart card module in the smart card body as necessary in the conventional manufacturing processes. According to the present invention the smart card body is manufactured by means of a roll-to-roll-process so that only the semiconductor chip needs to be installed and the smart card body closed to produce a smart card. The smart card manufacturer can also make use of his existing roll-to-roll processes.

In addition, the smart card body according to the invention can also be incorporated in another larger smart card body. This is particularly advantageous when the smart card body is manufactured according to the 3FF smart card format, which represents a smart card format with reduced dimensions in comparison with the 1FF and 2FF smart card formats. A 3FF smart card body can thus be incorporated in another 1FF or 2FF smart card body, something that offers a smart card manufacturer even greater flexibility in smart card manufacturing.

It is particularly advantageous when the step involving the formation of a lead frame comprises the punching-out of the conductive layer, preferably consisting of copper, and the metallization, preferably by electroplating, of the punched-out conductive layer. A roll of copper can thus be punched out and metallized using a roll-to-roll process to produce a lead frame in a simple and low-cost manner.

When the second surface of the conductive layer is provided with second contacts, preferably made of gold, wherein the second contacts are used for contacting of the semiconductor chip to be incorporated, the semiconductor chip to be incorporated can easily be electrically connected to the lead frame.

When the casing layer is formed from an insulating injection-molded material, wherein a pre-punched dielectric layer is laminated onto the second surface of the conductive layer, and plastics material is injection-molded around the laminated conductive layer, it is possible to manufacture the casing layer in a simple and low-cost manner. In addition, this has the advantage that only one surface layer needs to be arranged on the casing layer in a subsequent process step once a semiconductor chip has been incorporated in the recess of the casing layer to produce a smart card. The process for the assembly of a smart card is thus simplified.

It is particularly advantageous to manufacture a large number of smart card bodies on a carrier strip, wherein the large number of smart card bodies can be detached from the carrier strip. The process for the manufacture of a smart card body is thus compatible with a roll-to-roll process, something that provides for a simple and low-cost manufacturing process. The large number of smart card bodies is manufactured on a roll and can be supplied to a smart card manufacturer, who then only has to fit a semiconductor chip in the smart card body and close the smart card body to produce a smart card.

According to the present invention a process for the assembly of a smart card is described, wherein the process comprises the fitting of a semiconductor chip in the recess of the casing layer of the manufactured smart card body and closing of the recess in the casing layer of the smart card body.

A smart card is thus manufactured in a simple and low-cost manner. In addition, the process for the assembly of a smart card offers a smart-card manufacturer the advantage that the manufacture of a smart card can be carried out more quickly, above all when the smart cards are manufactured by means of a roll-to-roll process. As the smart card bodies are supplied on a roll ready for use, it is only necessary to fit the semiconductor chip in the smart card body and to close the smart card body in order to manufacture the smart card. The surface layer of the smart card body can also be personalized, for example provided with labeling.

It is particularly advantageous when closing of the recess in the casing layer of the smart card body comprises the lamination of a strip over the recess. It is thus possible to close the smart card bodies in a simple, fast and low-cost manner.

What is claimed is:

1. A method of manufacturing a smart card body adapted for incorporating a semiconductor chip, the method comprising the steps of:
forming a lead frame in a conductive layer, wherein the lead frame has a first contact on a first surface and can be connected to a semiconductor chip on a second surface opposite the first surface; and
forming an electrically insulating casing layer on the second surface, wherein the casing layer has a recess for incorporating the semiconductor chip.

2. The method of manufacturing a smart card body according to claim 1, wherein the lead frame is formed by a punching-out of the conductive layer, wherein the conductive layer preferably consists of copper, and wherein the punched-out conductive layer is metallized preferably by electroplating.

3. The method of manufacturing a smart card body according to claim 1, further comprising the step of:
providing the second surface with second contacts for contacting the semiconductor chip, the second contacts preferably being constructed of gold.

4. The method of manufacturing a smart card body according to claim 1, further comprising step of:
laminating a pre-punched dielectric layer onto the second surface.

5. The method of manufacturing a smart card body according to claim 4, further comprising the step of:
forming a casing layer by injection-molding a plastic material around the conductive layer.

6. The method of manufacturing a smart card body according to claim 1, wherein a plurality of smart card bodies are manufactured on a carrier strip and the smart card bodies are detachable from the carrier strip.

7. A method of assembling a smart card, comprising the steps of:
fitting a semiconductor chip in a recess in a casing layer of a smart card body manufactured by forming a lead frame in a conductive layer, wherein the lead frame has a first contact on a first surface and can be connected to a semiconductor chip on a second surface opposite the first surface and forming an electrically insulating casing layer on the second surface, wherein the casing layer has a recess for incorporating the semiconductor chip; and
closing the recess in the casing layer of the smart card body.

8. The method of assembling a smart card according to claim 7, wherein the step of closing the recess is accomplished by laminating a strip onto the recess in the casing layer of the smart card body.

9. A smart card body adapted for incorporating a semiconductor chip, the smart card body comprising:
a conductive layer structured to form a lead frame having a first surface having first contacts and a second surface opposite the first surface, the second surface being connectable to the semiconductor chip; and
an electrically insulating casing layer on the second surface, the casing layer having a recess for incorporating the semiconductor chip.

10. The smart card body according to claim 9, wherein the conductive layer is preferably constructed of copper and is punched out.

11. The smart card body according to claim 9, wherein the second surface comprises a second contact for contacting the semiconductor chip and wherein the second contact is preferably constructed of gold.

12. The smart card body according to claim 9, wherein the second surface comprises a pre-punched dielectric layer.

13. The smart card body according to claim 12, wherein the casing layer consists of a plastics material which is preferably injection-molded.

14. A carrier strip, comprising:
a plurality of smart card bodies, each smart card body comprising:
a conductive layer structured to form a lead frame having a first surface having first contacts and a second surface opposite the first surface, the second surface being connectable to the semiconductor chip; and
an electrically insulating casing layer on the second surface, the casing layer having a recess for incorporating the semiconductor chip;
wherein the conductive layer is preferably constructed of copper and is punched out;
wherein the smart card bodies are detachable from the carrier strip.

15. A smart card, comprising:
a semiconductor chip;
a smart card body, comprising:
a conductive layer structured to form a lead frame having a first surface having first contacts and a second surface opposite the first surface, the second surface being connectable to the semiconductor chip; and
an electrically insulating casing layer on the second surface, the casing layer having a recess for incorporating the semiconductor chip;
wherein the semiconductor chip is affixed in the recess; and
a surface layer for closing the recess.

16. The smart card according to claim 15, wherein the surface layer comprises a laminate.

17. The smart card according to claims 15, wherein the smart card comprises a Subscriber Identity Module (SIM) card.
